(19) United States
(12) Patent Application Publication
(10) Pub. No.: US 2016/0260166 A1
(43) Pub. Date: Sep. 8, 2016

(54) Identification, curation and trend monitoring for uncorrelated information sources

(71) Applicant: Trade Social, LLC, Dallas, TX (US)

(72) Inventors: Chris Camillo, Dallas, TX (US); Jordan McLain, Dallas, TX (US)

(21) Appl. No.: 14/635,585

(22) Filed: Mar. 2, 2015

(51) Int. Cl. G06Q 40/00; G06Q 50/00

(52) U.S. Cl. CPC G06Q 40/00; G06Q 40/04; G06Q 50/01

(57) ABSTRACT

An identification, curation and trend monitoring method and system provide information about private or publicly-traded companies by correlating multiple information sources. The approach provides for a highly-scalable, highly-available information management system and method that processes huge amounts of uncorrelated (and possibly unstructured) data and generates notifications or other alerts when information therein indicates relevant information about an object of interest, typically a publicly-traded company represented by a stock symbol. Users of the system are provided with notifications or alerts (about the company) when the system discerns significant social media chatter and/or company-specific news flow with respect to a particular stock symbol.

### TECHNICAL FIELD

This disclosure relates in general to the field of information systems data processing, and more particularly to processing large volumes of social media, news, website, and other uncorrelated information.

### BACKGROUND

Without limiting the scope of this disclosure, its background is described in connection with using the web, social media, news, and other rapidly evolving data outlets as a rich source of relevant real-time information. Each year the pace of data creation is accelerating, requiring both corporations and individuals to seek out new and relevant details regarding products, services, and topics in which they have a vested interest. A study by the IDC Digital Universe states that the world's information doubles every 1.5 years. In fact, the global internet population from 2011-2013 grew 14.3% and now represents over 2.4 billion people. While a majority of the internet's information may contain no valuable insight related to a particular corporation's future stock price or the long term viability of a brand new product, millions upon millions of data pockets containing highly valuable facts occur each second.

Due to the large volumes of information generated each day, it is impossible to monitor everything. Twitter users tweet approximately 277,000 times per minute while Facebook users share around 2.46 million pieces of content during the same amount of time. While most of this data is merely noise, it is a fact that this noise often becomes chatter, and many times the chatter is actually relevant or very valuable information in the earliest stages. Some investment corporations, such as Bridgewater, Artemis, and Mediolanum Asset Management, already publically disclose the incorporation of online information into their core investment strategies. During April 2013, the SEC deemed social media outlets as an acceptable information dissemination medium for material non-public information as long as the market has been notified that the channel is being used for such a purpose.

Relevant information curation is not only essential, but it is also a mission critical component for strategic individuals, corporations, investors, producers, consumers, and the like. Due to the massive growth and production of new data, however, very few find themselves on the forefront of identifying valuable, topic relevant facts in the earliest stages. The flood of Internet noise drowns out valuable facts making even the top performers in this field reactionary at best.

Therefore, there is currently a need for a system and method to efficiently organize and curate unstructured information sources, associating them with their relevant topics, and alerting vested individuals at the first moment when noise or chatter becomes a pocket of potentially highly valuable information.

### SUMMARY

According to one embodiment this disclosure, an identification, curation and trend monitoring method and system provides information, e.g., about publicly-traded companies, by correlating multiple information sources. The approach provides for a highly-scalable, highly-available information management system and method that processes huge amounts of uncorrelated (and possibly unstructured) data and generates notifications or other alerts when information therein indicates relevant information about an object of interest, typically a publicly-traded company represented by a stock symbol. In one embodiment, a method is operative to identify information about a publicly-traded company having an associated ticker symbol. It begins by receiving and parsing media content to generate a ranked set of ticker terms other than the associated ticker symbol. Then, one or more of the ranked set of ticker terms for that publicly-traded stock of interest are monitored in real-time against one or more social media content streams; during monitoring, a given ticker term instance within the one or more social media content streams is aggregated for trend analysis provided its usage within the social media content stream has been shown to satisfy a context measure, e.g., a machine learning (ML)-based measure. When the results of the real-time monitoring and the trend analysis provide an indication that a particular ticker term is trending within the one or more social media content streams to a configurable degree, the particular ticker term and its associated publicly-traded stock of interest are flagged for notification.

The set of ticker terms associated with a particular publicly-traded stock comprise a tag library. The above-described method enables curated social media intelligence for use, e.g., by financial services markets. Users of the system are provided with notifications or alerts (about the company) when the system discerns significant social media chatter and/or company-specific news flow with respect to a particular ticker term.

Generally, the disclosed subject matter is a computer-implemented system and method for the identification, curation, trend monitoring, and dissemination of relevant ticker term information; in one embodiment, a representative method includes the steps of: capturing web, social media, or other relevant information sources related to one or more ticker terms (sometimes referred to as “tags”) and placing the information into a document store, sequencing documents to extract relevant ticker term words and phrases, scoring and ranking ticker terms and media content or documents in relation to those words and phrases, populating a search engine to present the most relevant collected information sources for any known ticker term and media content within a system, and monitoring the words and phrases across known social media, blog, RSS and other Internet information sources in real-time for statistically significant changes in references related to known ticker terms. Users are then alerted (e.g., by text, e-mail, call, or the communication or message) to these changes, preferably in real-time.

Both advantages and features of the disclosed subject matter may be better understood by reviewing the preferred embodiments within the detailed description which is provided in combination with the accompanying drawings. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the disclosed subject matter and its advantages, reference is now made to the following description and the accompanying drawings, in which:

FIG. 1 illustrates a schematic diagram of an exemplary Ticker Tag Identification, Curation, and Trend Monitoring System;

FIG. 2 illustrates a schematic diagram of an exemplary Ticker Tag Sequencer System;

FIG. 3 illustrates a schematic diagram of an exemplary Ticker Tag Term Scoring and Ranking System;

FIG. 4 illustrates a schematic diagram of an exemplary Ticker Tag Term and Phrase Media Monitor;

FIG. 5 illustrates a process flow of an exemplary Media Content Sequencing Method;

FIG. 6 illustrates a process flow of an exemplary Method for Term Scoring and Ranking;

FIG. 7 illustrates a process flow of an exemplary Media Monitoring Method; and

FIG. 8 illustrates how multiple word phrases can be extracted from a word feature space to facilitate machine learning according to this disclosure.

### DETAILED DESCRIPTION

Embodiments of the disclosed subject matter and its advantages are best understood by referring to the following figures, with like numerals being used for like and corresponding parts of the various drawings. While making and using of multiple embodiments are presented in detail below, it is appreciated that the disclosed subject matter teaches many applicable concepts which may be embodied in numerous varieties of specific contexts.

All embodiments presented herein are merely illustrative and are not intended to limit the scope of this disclosure in any way. For instance, the subject matter is described with respect to “Ticker Tags,” which comprise terms that may be associated with stock symbols of publicly-traded companies. Thus, for example, with respect to a publicly-traded company such as Disney, a set of Ticker Tags may comprise such terms as: “Sports Center,” “Frozen,” “Star Wars,” “Avengers,” “Disney Channel,” “Toy Story,” “Nemo,” “Into The Woods,” and so forth. Depending on context, a particular use of a particular ticker term at a given frequency may reflect information of interest with respect to the term's associated stock (as represented by the stock symbol). More generally, a “Ticker Tag” may comprise any term of phrase regarding any information topic or subject that may require identification, curation, and trend monitoring for anyone with a vested interest in the aforementioned topic or subject.

Many terms are used below which assist in the facilitation of understanding this subject matter. While the terminology may be used to describe specific embodiments of the disclosed subject matter, their usage should not be taken as limiting.

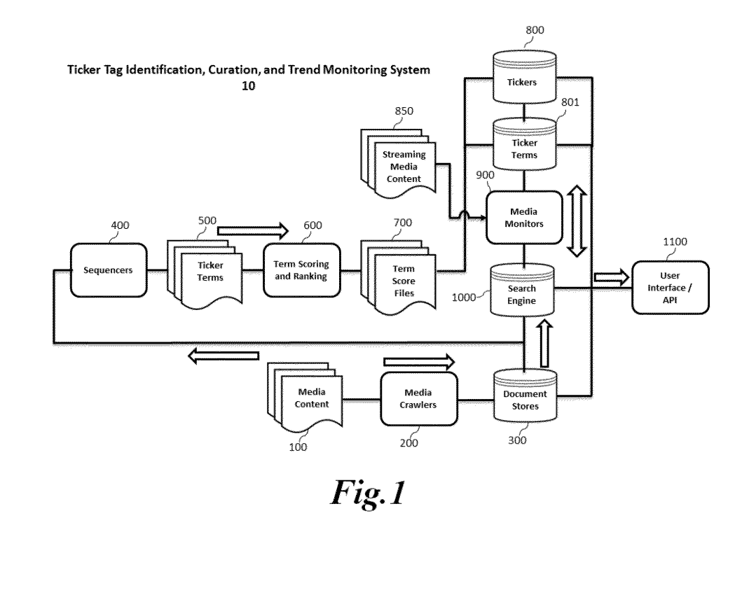

With reference to FIG. 1, there is shown a Ticker Tag Identification, Curation, and Trend Monitoring System platform 10 according to an exemplary embodiment of the disclosed subject matter. The exemplary System 10 embodiment comprises one or more of each element including: one or more Media Crawlers 200 conducive to processing Media Content 100, one or more Document Stores 300 for maintaining content produced by the Media Crawlers 200, one or more Sequencers 400 which process each entry within the Document Stores 300 and produces one or more Ticker Terms 500 collections, one or more Term Ranking and Scoring Systems 600 processing one or more Ticker Terms 500 collections and producing one or more Term Score Files 700, one or more Tickers 800 data stores maintaining all unique Ticker Tags within the system, one or more Ticker Terms 801 data stores maintaining the most recent Term Scores produced by the Term Ranking and Scoring Systems 600, one or more Media Monitors 900 Systems for monitoring all known Ticker Tags and known Ticker Tag Terms and Phrases across all social media and other internet Streaming Media Content 850 data sources known to the system, and a Search Engine System 1000 accessible to the User Interface and API 1100 providing both relevant media content and streaming media content monitoring information collected by the System 10 to vested User Interface and API 1100 system users.

The System 10 includes a plurality of server computers supporting the User Interface/API 1100 and a plurality of client or server computers accessing the User Interface/API 1100.

Generalizing, one or more functions of such a technology platform as shown in FIG. 1 may be implemented in a cloud-based architecture. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications).

The platform may comprise co-located hardware and software resources, or resources that are physically, logically, virtually and/or geographically distinct. Communication networks used to communicate to and from the platform services may be packet-based, non-packet based, and secure or non-secure, or some combination thereof.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

Within the exemplary System 10 embodiment, relevant Media Content 100 is identified by one or more Media Crawlers 200 program modules or “engines.” Media Content 100 could be collected from a number of different sources including RSS feeds or keyword searches using common web search tools such as the Google Search API or custom web spiders/crawlers such as Scrapy.

In certain embodiments, Media Content 100 could comprise webpage media content accessible through the internet. Yet in other embodiments, Media Crawlers 200 program modules or “engines” could access media content from sources such as file systems, disk drives, servers, databases, or any other system containing relevant Media Content 100. While certain embodiments may obtain documents from web-based sources, some embodiments may collect Media Content 100 placed on many other types of storage mediums including file systems, disk systems, flash drives, removable optical or disk media, and other data sources accessible to copy Media Content 100.

In certain embodiments related to the curation of financial or investment-related ticker terms, the Media Crawlers 200 may comprise a plurality of custom “ticker spiders” including spiders/web crawlers for RSS feeds, Google, Yahoo and any other custom ticker spiders/crawlers which may be well known or common in the art. Ticker spider applications executing within such an embodiment, would collect web or other documents specifically related to the stock symbols of publically traded companies. However, some Media Crawlers 200 may be configured to generate and associate ticker terms with any source and or type of web and/or document content. The use of stock symbols from publicly-traded companies as Ticker Tags is merely one preferred embodiment of Ticker Tag usage. This subject matter, however, is not limited to “Ticker Tags,” which in one embodiment are associated with stock symbols of publicly-traded companies. The techniques may be used with respect to terms associated with privately-held companies as well. More generally, the techniques may be used to identify, curate and trend monitor for objects of interest.

In certain embodiments, displayed text may be extracted by removing all HTML related tags and symbols from the document using any common HTML parser, such as the HTML Agility Pack, Beautiful Soup, or Watin. Furthermore, other common document text extraction techniques may be used such as optical character recognition or other software packages and plugins to handle extracting relevant text content from particular types of data and files. In certain embodiments, software may be used to extract text from various file types such as Adobe PDF, Microsoft Word, Excel, Powerpoint, and Access files. Yet in other embodiments, various software packages may be used to extract text from XML data, and any other common data or file types which may be well-known in the art and encountered while the Media Crawlers 200 is searching for Ticker Tag relevant content.

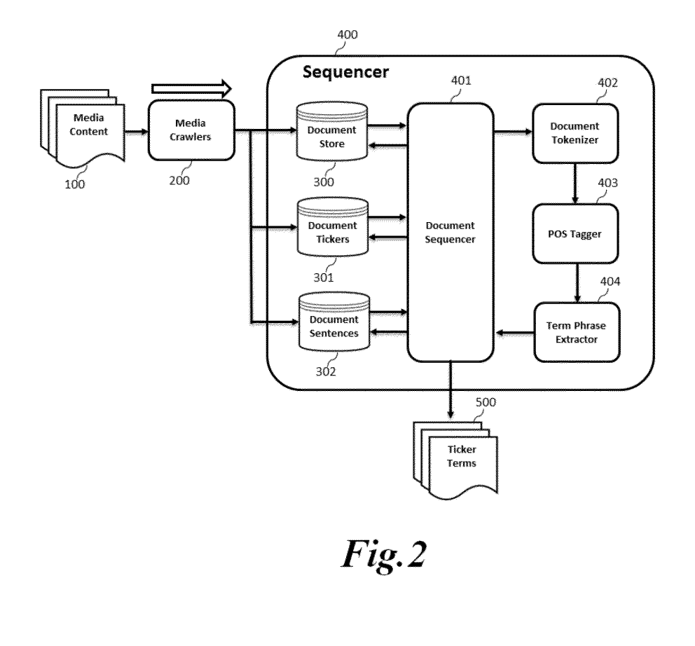

Once a Media Crawlers 200 has identified a Media Content 100 source, the content is downloaded or copied, the content's relevant text is extracted, and the resulting information is placed within an entry in a Document Stores 300. In certain embodiments, the Media Crawlers 200 may also identify Ticker Tags within the Media Content 100's relevant text placing the identified Ticker Tag and Document Id with a Document Tickers 301 data structure entry such as shown in FIG. 2.

Furthermore, some Media Crawlers 200's processing may also comprise the identification of sentences within the Media Content 100's relevant text. This process is described in greater detail below. In such embodiments, each sentence identified by the Media Crawlers 200 would be placed in a Document Sentences 302 entry (as shown in FIG. 2) along with the document id. In certain embodiments, both of the aforementioned processes may be handled by a Sequencer 400 system as also reflected in FIG. 2.

The Document Stores 300 preferably comprises a database server or other similar system which stores information including a unique document identifier, such as a UUID, hash code, auto-incremented key, or any other piece of data which could be used as a unique identifier of a document within the system. The URL, URI, file path, or other originating location of the document and the document's displayed text are also placed within each Document Stores 300 entry for further downstream processing. Each document entry within the Document Stores 300 is processed by at least one Sequencers 400 system. Certain embodiments could include multiple Document Stores 300 data stores and or multiple Sequencers 400 systems.

While some embodiment System 10 data store configurations may use local servers managed in-house, other system embodiments may be fully implemented in a cloud managed configuration such the Amazon S3 service. Furthermore, other embodiments may choose a hybrid solution where multiple data stores reside both locally and in a cloud managed configuration. Yet in other embodiments, a plurality of System 10 data stores may operate in parallel to service only portions of the data entries contained therein.

In one example embodiment, the Document Stores 300 data stores may operate in parallel to service only portions of the documents collected by one or more Media Crawlers 200 program modules or instances. In such an embodiment, the documents may be partitioned or divided amongst Document Stores 300 data stores in any number of ways including dividing documents by source, topic, size, or using any kind of workload balancer or “node manager” which may be common in systems where Document Stores 300 data stores comprise key-value pair data stores using any number of commodity hardware partitioned nodes for additional storage and or processing throughput.

The System 10 data stores may include one or more data structures which could comprise any type of data structure meeting the basic requirements for a particular embodiment. For example, System 10 data store data structures could comprise in-memory database tables, relational database tables, flat files, text files and the like. It is preferable that the System 10 data store data structures be able to receive new entries while simultaneously servicing requests to provide unprocessed data entries to any number requesting systems, program modules, or other data stores. In one embodiment, for example, it is preferable that the Document Stores 300 be able to receive new document entries from the Media Crawlers 200 while simultaneously servicing requests to provide unprocessed document entries to any number of Sequencers 400 system program modules or instances.

In some embodiments, it may advantageous for an exemplary System 10 to be designed in a highly-parallel MapReduce or Producer/Consumer style processing pipeline. In such an embodiment, multiple instances of each element reflected within the System 10 may be replicated on multiple processors and or servers to support system scalability and processing throughput.

During one Media Crawlers 200 processing embodiment, for example, a plurality of Media Crawlers 200 program modules (mapping nodes) may be extracting the text from relevant documents (web or otherwise) and mapping this text into Ticker Tag Terms and Phrases in parallel. Simultaneously, a plurality of Document Stores 300 data store data structures may be available to accept each “mapped” Document Stores 300 entry in a fully thread-safe manner with all “mapped” entries being divided between Document Stores 300 data store nodes in an acceptable manner as previously described. In addition, a plurality of Sequencers 400 systems (reducing nodes) may be simultaneously available and reducing each of the Document Stores 300 node entries as they arrive for processing. In this manner, multiple processors and/or multiple servers may be performing various stages of the System 10 processing at the same time and in parallel.

In such embodiments, MapReduce processing software and database systems conducive to parallel MapReduce implementations such as Hadoop, Map-R, or Oracle's BerkeleyDB may be used for various System 10 data structures and parallel processing pipeline stages. Yet in other embodiments, these data structures and parallel processing pipeline stages could be implemented in lower level programming languages such as C#.

For example, such a C# implementation may use the Parallel and or PLINQ classes in combination with data structures from the System.Collections.Concurrent namespace to create a parallel producer/consumer processing pipeline. In this embodiment, a Parallel.ForEach processing loop could be used for Media Crawlers 200 processing placing each resulting output record into a thread-safe BlockingCollection from the System.Collections.Concurrent namespace that encapsulates a Document Stores 300 data store data structure designed to hold Document Stores 300 entries. Simultaneously, a second Parallel.ForEach processing loop may be executed in one or more reduction threads for reducing the BlockingCollection's Document Stores 300 entries and performing the Sequencers 400 system's processing tasks. In this scenario, each of the Sequencers 400 system's processing stages and tasks may also be operating in parallel processing stages using either MapReduce style processing software or a lower level language to create such a parallel processing pipeline implementation as described above.

While C# was used for describing the previous lower level language embodiment, any programming language supporting parallel programming implementations could be used for such a similar purpose. In addition, these same software and parallel programming implementations and concepts could be applied to any portion of the System 10 or any portion of any individual element of the System 10 embodiment.

For instance, in one example embodiment, as one or more Sequencers 400 program modules are generating Ticker Terms 500 collections in parallel using MapReduce style software or lower level parallel pipeline programming implementations, one or more Term Scoring and Ranking 600 program modules could be performing portions of the Term Scoring and Ranking 600 processes in parallel as each individual Ticker Term or entire Ticker Terms 500 collections arrive. Yet in other embodiments, all stages of the Sequencers 400 program module and/or all stages of the Term Scoring and Ranking 600 program module could be operating in similar parallel pipeline or MapReduce stages as previously described.

In the FIG. 1 System 10 embodiment, the Search Engine 1000 in combination with the User Interface/API 1100 provides access to all curated Media Content 100 and all curated Streaming Media Content 850 data which is associated with any Tickers 800 data entries and or any Ticker Tag Terms and Phrases contained within the Ticker Terms 801 data stores. Furthermore, the Search Engine 1000 in combination with the User Interface/API 1100 provides users and other systems (via the API), the ability to search Ticker Tags, Ticker Tag Terms and Phrases, Media Content 100, and Streaming Media Content 850 for content containing any Ticker Tags or Ticker Tag Terms and Phrases of interest to the user.

In certain embodiments, identified content returned by the Search Engine 1000 in combination with the User Interface/API 1100 could be presented in any number of ways which may be desirable for a given system embodiment and/or user search request. The Search Engine 1000 in combination with the User Interface/API 1100 may only provide raw Media Content 100, and Streaming Media Content 850 to requesting users in a more simplistic embodiment. While a more sophisticated implementation may comprise access to additional views of the content and/or additional content specific statistics for a given search request.

For example, a preferred embodiment's Search Engine 1000 in combination with the User Interface/API 1100 may provide not only Media Content 100 and Streaming Media Content 850, but also may provide data elements such as: the text or sentence locations where Ticker Tags and/or Ticker Tag Terms and Phrases were identified, the frequency of Ticker Tags and/or Ticker Tag Terms and Phrases occurrence within each content element, Media Content 100 and Streaming Media Content 850 individual content ranks based upon the Ticker Tags and/or Ticker Tag Terms and Phrases provided, historical information about content and frequencies for the Ticker Tags and/or Ticker Tag Terms and Phrases requested. Yet in other embodiments, a number of additional text related features might be provided resulting from the system's Natural Language Processing (as described in greater detail below) such as the sentences and tagged parts of speech for all the terms within each content item returned.

In some embodiments, Media Content 100 and/or Streaming Media Content 850 references identified by the Media Monitors 900 and the Media Crawlers 200 could be monitored by various portions of the System 10 for significant or relevant changes in reference to any number of Ticker Tags and/or Ticker Tag Terms and Phrases. These System 10 processes are described in greater detail within the illustrations and teachings below.

Referring to FIG. 2, the Sequencers 400 system typically comprises at least one Document Sequencer 401 program module or engine which consumes the raw document entries contained within one or more Document Stores 300, Document Tickers 301, and Document Sentences 302 data stores. The Document Sequencer 401 controls multiple program modules or engines including: a Document Tokenizer 402, POS Tagger 403, and the Term Phrase Extractor 404.

In some embodiments, one or more Document Sequencer 401 program modules may access one or more Document Stores 300, Document Tickers 301, and Document Sentences 302 data stores for raw document inputs. In certain embodiments, the Document Sequencer 401 may also populate the Document Sentences 302 data structure with all sentences extracted from a document's raw text, and the Document Tickers 301 data structure with any new “Ticker Tags” associated with a particular document. Yet in other embodiments, the Document Sentences 302 and Document Tickers 301 data stores may be populated by one or more Media Crawler 200 instances.

The Document Tokenizer 402 is responsible for parsing the raw text contained within each of the Document Stores 300 or Document Sentences 302 entries. The raw text processed by the Document Tokenizer 402 could be tokenized in any number of ways preferable to any number of embodiments. For example and in its most basic form, document text could be tokenized using only whitespace (i.e. spaces) to separate each of the word tokens contained within a document. In other embodiments, Document Tokenizer 402 may tokenize document raw text using any number of variable length n-grams such as 1-grams, 2-grams, and 3-grams. For example and in the n-gram tokenization embodiment, the sentence “I like college football” contains the 1-grams: “I, like, college, and football”, 2-grams: “I like, like college, and college football” and 3-grams: “I like college, and like college football”.

Any other document tokenization technique, algorithm, or software package may be used to generate media content text tokens that are suitable for the Term Phrase Extractor 404's subsequent identification of Ticker Tag Terms and Phrases. For instance, Natural Language Processing (NLP) techniques may be used within the Document Tokenizer 402 and during the tokenization of text. In this embodiment, the Document Tokenizer 402 utilizes the POS Tagger 403 to detect sentence boundaries and/or identify each word's part of speech for use during tokenization.

In certain embodiments, an NLP processing package such as the NLTK (Natural Language Toolkit) could be used to detect sentence boundaries and in tagging the Part of Speech (POS) for each word within each sentence. From this point tokenization could be performed by selecting or discarding certain tokens based upon the Part of Speech tag. The Document Tokenizer 402 tokenizes the document's raw text using any of the strategies described above and providing its tokenized output to the POS Tagger 403, if Natural Language Processing was not already performed during the Document Tokenizer 402 processing step.

In certain embodiments, either the Document Sequencer 401 or the Document Tokenizer 402 uses the POS Tagger 403 to identify sentence boundaries and/or Parts of Speech for use in the identification of Ticker Tag Terms or Phrases that are individual terms or phrases associated with a particular “Ticker Tag.” However, some embodiments may not use an active POS Tagger 403 or any Natural Language Processing during the Document Sequencer 401 process.

In such embodiments, it can be envisaged that words of interest could be loaded into a hash table and looked up to avoid the overhead of Natural Language Processing altogether. In such scenarios, each token in the form of a 1-gram, 2-gram, 3-gram, or any other token combination desired might simply be looked up in a hash table or other appropriate data structure to determine information, such as the word's most common part of speech, or to confirm if a particular term or phrase is contained within a list of known terms or phrases.

In some embodiments, the Document Sequencer 401 provides each token or combination of tokens and other relevant token information such as the token's Parts of Speech, beginning of sentence indicator, beginning of paragraph indicator, contains uppercase indicator, and word is all caps indicator, to the Term Phrase Extractor 404. While the aforementioned items could be the only pieces of relevant token information within a particular embodiment, many other types of relevant token information may be used. Relevant token information is simply information used by the Term Phrase Extractor 404 or within a Sequencers 400 system to assist in the identification of Ticker Tag Terms and Phrases.

In basic embodiments, the Term Phrase Extractor 404 could comprise simple heuristics to identify noun phrases based upon word proximities, sentence boundaries, paragraph boundaries, and parts of speech. For example, the part of speech could be used to identify all nouns during tokenization. From this point, the Term Phrase Extractor 404 could return individual nouns, noun bi-grams, and noun tri-grams as potential Ticker Tag Terms or Phrases. In this embodiment, noun bi-grams, and noun tri-grams would simply represent portions of text where 2 (bi-grams) or 3 (tri-grams) nouns occur in succession.

In one preferred Term Phrase Extractor 404 embodiment, however, more sophisticated machine learning techniques are applied to the tokens and token relevant information provided as input by the Document Sequencer 401 and used to identify potential Ticker Tag Terms and Phrases by the Term Phrase Extractor 404. For example, using a 7 word sliding window, where word “0” is the current word in a document, a machine learning feature space can be created to determine the existence of a Ticker Tag Term or Phrase of type “company,”, “product”, “person” or “none” within a 7 word sliding window.

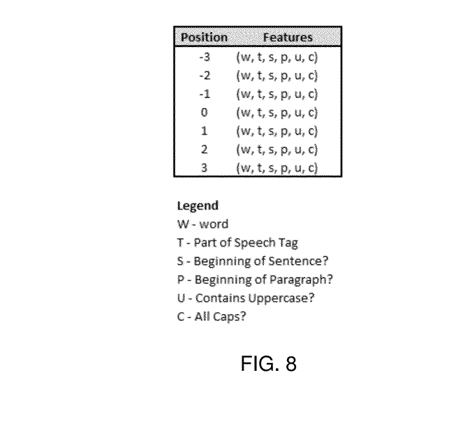

In the example shown in FIGS. 8, −1, −2, and −3 would represent the 3 words before the current word 0, and 1, 2, and 3 would represent the 3 words after the current word 0 within the 7 word sliding window feature space. As can be seen, in this example embodiment, each individual word feature space contains 6 word relevant features for a total of 42 features which are provided to the machine learning model to predict if the current word is a Ticker Tag Term or Phrase of type “company”, “product”, “person” or “none”. Of course, the 7 word sliding window is not intended to limit the disclosure.

Once each word type has been identified, multiple word phrases can be extracted by simply finding words with matching type tags that occur one after the other. For example, the following sentence contains 3 words identified as the type “company”: I like Texas (1) State (2) Bank (3). Because the 3 words “Texas State Bank” occur in succession and have matching the matching type “company”, they are captured as the phrase “Texas State Bank”.

Machine learning models for the identification of Ticker Tag Terms or Phrases may be created in any number of ways using many different types of machine learning techniques, such as Linear Regression, Support Vector Machines, Adaptive Boosting, or Decision Trees. These or other more customized machine learning algorithms could be developed in lower level languages such as C++ or C# as well as implemented using many available software packages or machine learning platforms. For example, certain embodiments could utilize Apache's Mahout Scalable Machine Learning and Data Mining package to develop highly parallel MapReduce style machine learning implementations. Yet in other embodiments, specialized statistical programming languages such as SAS, R, or IBM's SPSS may be deployed to produce the machine learning models utilized for Ticker Tag Term and Phrase identification.

In some embodiments, additional quality control measures may be put in place to further increase the quality of the potential Ticker Tag Terms or Phrases generated by the Term Phrase Extractor 404. In more automated embodiments, Ticker Tag Terms or Phrases of type “company” for example could be looked up from a list of “known” companies and flagged as either “known” or “unknown”. In yet other embodiments which are less automated and more focused on Ticker Tag Term or Phrase quality, human or partially machine-supported curators could be used to review and validate any type “company”, “product”, or “person” terms or phrases that have been flagged as “unknown”. Finally, some embodiments may have human or partially machine-supported curators approve all potential Ticker Tag Term or Phrases, and other embodiments may use no human curators or Ticker Tag Term or Phrase approvals at all.

All Ticker Tag Term or Phrases identified by the Term Phrase Extractor 404 are placed into the Ticker Terms 500 collection by the Document Sequencer 401. The Ticker Terms 500 collection data structure may comprise any valid System 10 data structure as previously described. Furthermore, multiple Sequencers 400 systems could produce multiple Ticker Tag Terms and Phrases and multiple Ticker Terms 500 collections simultaneously in parallel using the methods previously described. In certain embodiments, one or more Ticker Terms 500 collections await further downstream processing by one or more Term Scoring and Ranking Systems 600.

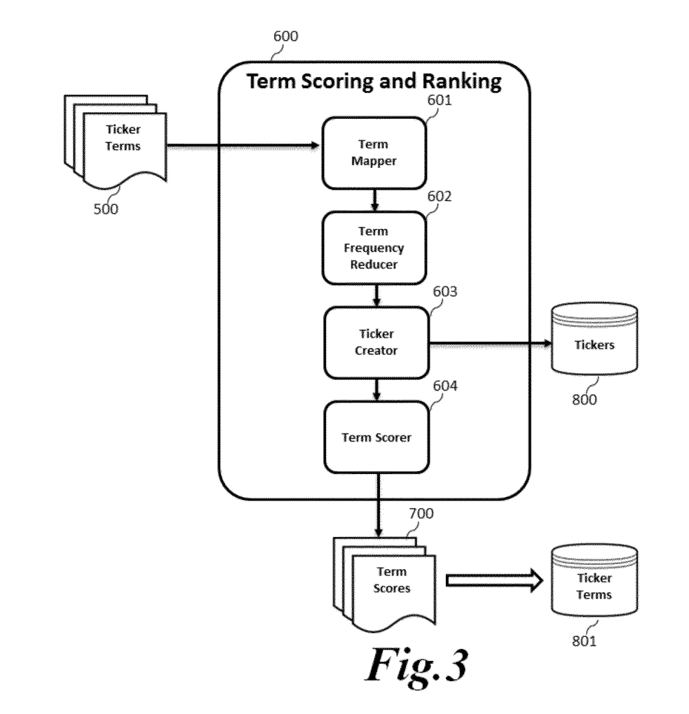

Referring to FIG. 3, an exemplary Term Scoring and Ranking System 600 embodiment is illustrated including a Term Mapper 601, Term Frequency Reducer 602, Ticker Creator 603, and Term Scorer 604. The Term Scoring and Ranking System 600 processes as input one or more Ticker Terms 500 collections and produces as output one or more collections of Term Scores 700.

The Term Scoring and Ranking System 600 includes one or more Term Mapper 601 program modules or engines which operate on one or more Ticker Terms 500 collections to map all Ticker Tag Terms and Phrases identified within each Ticker Terms 500 collection entry to a particular Document Stores 300 unique identifier. The Term Mapper 601 program can execute in parallel using multiple instances to improve scalability and throughput. The Term Mapper 601 simply provides each of the individually mapped Ticker Tag Terms or Phrases to await reduction processing by one or more Term Frequency Reducer 602 program modules.

In certain embodiments, one or more Term Frequency Reducer 602's can execute in parallel using multiple processing instances to improve scalability and throughput. The Term Frequency Reducer 602 processes each individually mapped Ticker Tag Term or Phrase counting its occurrence within each unique Document Stores 300 entry and also counting its occurrence in aggregate across all known Document Stores 300 entries. In certain embodiments, the Term Frequency Reducer 602 may also count Ticker Tag Term or Phrase occurrence by Ticker Tag as well.

During Term Scoring and Ranking 600 processing, the Ticker Creator 603 identifies any unknown Ticker Tags and places them into the Tickers 800 data store. The order of when new Ticker Tags are added into the Tickers 800 data store could be modified in various embodiments of the Term Ranking and Scoring System 600 to change performance characteristics of the system.

The Term Scorer 604 may use the Ticker Tag term, phrase, and Media Content 100 item/Document Store 300 entry frequencies produced by the Term Frequency Reducer 602 to create Term Frequency/Inverse Document Frequency (TF/IDF) statistics for each Ticker Tag and/or Media Content 100 item/Document Store 300 entry known within System 10.

However, in one preferred embodiment, the Term Scoring and Ranking System 600 performs Latent Semantic Analysis where the Term Mapper 601 maps and calculates the frequency of Ticker Tag Terms and Phrases by paragraph within a Media Content 100 item's text, and the Term Frequency Reducer 602 reduces each unique Ticker Tag Term or Phrase into a matrix containing unique Ticker Tag Term and Phrase frequencies by paragraph. Next, single value decomposition is performed to reduce the number of unique Ticker Tag Terms and Phrases while preserving the similarity structure between paragraphs.

Finally, Term Scores 700 entries are calculated, e.g., by taking the cosine of the angle between all unique term vectors formed by the unique Ticker Tag Terms or Phrases assigned to an individual Ticker Tag or included within unique Document Store 300 entry. This is also the dot product between the normalizations of the unique term vectors. Ticker Tag Terms or Phrases can then be scored for relevance rankings against either Ticker Tags or Media Content 100 items in a Document Store 300 using the final Ticker Tag Terms and Phrases—Ticker Tag Matrix or the Ticker Tag Terms and Phrases—Media Content Matrix which describes the relevance of all Ticker Tag Terms or Phrases within each Ticker Tag or Media Content 100 item in the Document Store 300. In some embodiments, the both the Ticker Tag Matrix and the Media Content Matrix could further be reduced into “low-rank approximations” of their original versions to reduce processing overhead, noise, or for other accuracy and/or performance reasons.

In certain embodiments some or all of the Term Scoring and Ranking 600 processes could be performed by one or more software packages or be entirely implemented using a lower level programming language. In one example embodiment, a Term Scoring and Ranking 600 system could be created using Amazon's Elastic MapReduce cloud based MapReduce system.

In this embodiment, the Elastic MapReduce processes could be used for the Term Mapper 601 and the Term Frequency Reducer 602. For example, using the Python programming language, an instance of the Amazon Elastic MapReduce program could be defined including job steps for the Term Mapper 601, the Term Frequency Reducer 602, and TF/IDF term scoring could be performed using Lucene for tokenization and Mahout for creating the TF/IDF score vectors within the Term Scorer 604 job step process. Finally, after the map, reduce, and scoring steps 601-603 are completed, Python is used once again to load the final results into the Term Scores 700 collection. The one or more Term Scores 700 collections are then eventually propagated into the Ticker Terms 801 data structure after their creation.

Term Scores 700 collection propagation could be managed in any number of ways based upon the specific goals of a particular System 10 embodiment. In one example embodiment where many Document Stores 300 data stores are utilized, a plurality of Term Scoring and Ranking 600 program module instances may be utilized to service any number of Document Stores 300 data stores. In this embodiment, as each Term Scores 700 collection is created, the collection could then be scheduled for propagation into one or more Ticker Terms 801 production data stores. Using such a staged propagation approach may allow some embodiments to balance Term Scoring and Ranking 600 system workloads more effectively. Yet in other embodiments, parallel processing techniques may be used to map Ticker Tag Terms and Phrases into Term Scores 700 collections while other “reduce” threads or processes are propagating completed Term Scores 700 collection entries into one or more Ticker Terms 801 data stores. Using a MapReduce style propagation approach may be preferred in particular embodiments where propagation latency must be minimized.

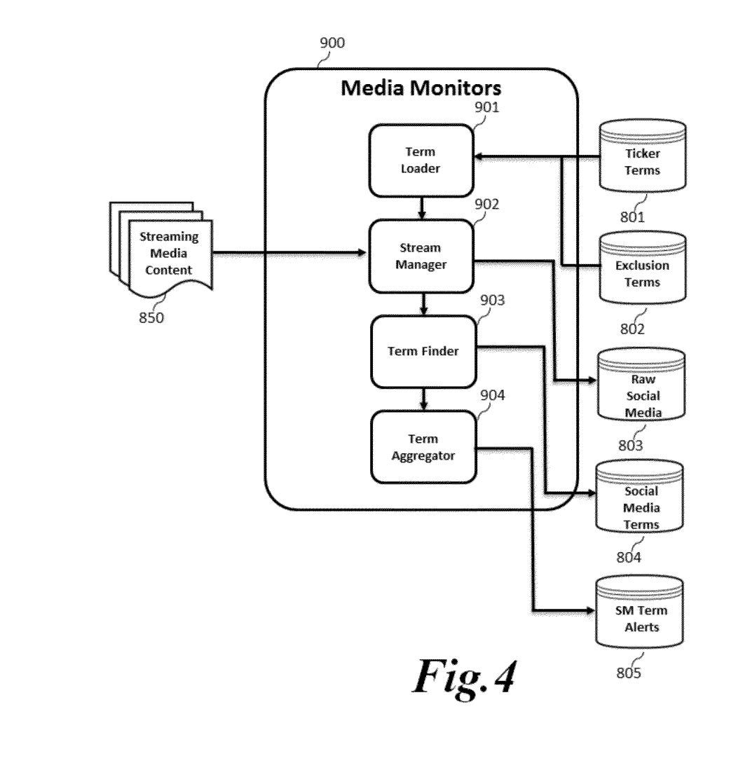

Referring to FIG. 4, there is shown a Media Monitors 900 Program Module or Engine according to an exemplary embodiment that is designed for the highly scalable, real-time processing and monitoring of streaming data at a massive scale. The Media Monitors 900 program module embodiment illustrated in FIG. 4 includes a Term Loader 901, Stream Manager 902, Term Finder 903, and a Term Aggregator 904. The Media Monitors 900 program module processes Streaming Media Content 850 as input, and produces any number of outputs from processing the Streaming Media Content 850 as required by a particular embodiment and as described in greater detail below.

In some embodiments, Streaming Media Content 850 is processed in real-time by the Media Monitors 900 program module which could include various forms of real-time streaming data. For example, Streaming Media Content 850 could include real time streaming data from Twitter including the text from tweets as they are posted by Twitter users. In other embodiments, Streaming Media Content 850 may comprise both tweets from Twitter and status updates from other social media websites such as Facebook, Google+, LinkedIn, Myspace, Instagram, and the like.

In addition to streaming data from social media, some embodiments of the Media Monitors 900 program module may monitor other sources of streaming data. In certain instances, this data may not be processed in real time, but rather in batches which arrive in various time intervals desirable to a particular Media Monitors 900 program embodiment. Certain embodiment's Streaming Media Content 850 may include portions of streaming text from other sources such as comments from blogs, document content, RSS feed content, news data, audio and video transcripts, and any other form of information which may require content monitoring for the occurrence of Ticker Tags Terms and Phrases. Streaming Media Content 850 data sources may not all be “streamed” data sources in some embodiments of the invention.

The Media Monitors 900 Program Module includes a Term Loader 901 for managing any form of terms and phrases relevant to a particular Media Monitors 900 program module embodiment. The Media Monitors 900 program module depicted in FIG. 4 illustrates the Term Loader 901 accessing both the Ticker Term 801 and Exclusion Terms 802 data stores for two different sets of terms and phrases which are relevant to a particular embodiment of the Media Monitors 900.

The Term Loader 901 may comprise a program module, such as a program written in a programming language like Python, C#, C++, or Java, or the Term Loader 901 may simply be implemented using a relational database management system such as Oracle, DB2, or MS SQL Server. Yet in other embodiments, terms and phrases managed within the Term Loader 901 may be loaded into Key-Value pair data structures which are maintained in memory for rapid access in embodiments processing high volume Streaming Media Content 850 data streams.

In the FIG. 4 embodiment, one or more Ticker Terms 801 data structures represent all or some defined subset of the Ticker Tag Terms and Phrases that are known to a particular Ticker Tag Identification, Curation, and Trend Monitoring System 10 as depicted in FIG. 1. In addition, one or more Exclusion Terms 802 data stores can include stop words which should be excluded for monitoring by the System 10. Words or phrases contained within the Exclusion Terms 802 data store may include items such as terms and phrases representing profanity or other terms and phrases which are considered not relevant for monitoring within a particular Streaming Media Content 850 data stream.

While some Media Monitors 900 embodiments may comprise multiple sources of Terms (i.e. Ticker Terms 801 and Exclusion Terms 802), it can be envisaged that other embodiments may only include one master set of terms which are of interest to a particular Media Monitors 900 embodiment. Yet in other embodiments, there may be multiple instances of the Stream Manager 902 program module each with dedicated terms lists that are loaded by one or more Term Loader 901 instances. It is possible in certain embodiments to purge the Ticker Terms 500 collections or the Ticker Terms 801 data stores of all Exclusion Terms 802 prior to any monitoring by the Media Monitors 900. In these embodiments, the Exclusion Terms 802 data store may not be used by the Term Loader 901.

The Stream Manager 902 is a program module or instance which connects to and processes streaming data from at least one or more Streaming Media Content 850 data streams. The Stream Manager 902 may comprise a program module, such as a program written in a programming language like Python, C#, C++, or Java, or be a more simple program interface which connects to a program API provided by a social media content provider such as FaceBook, Google+, LinkedIn, Myspace, Instagram, and the like. In some embodiments, the Stream Manager 902 may comprise a specialized web crawler which uses similar techniques as the System 10 Media Crawlers 200 (previously described) to seek and identify streaming internet data or “scrape” information from live web pages for real time monitoring and trend analysis. In certain embodiments, a Stream Manager 902 may connect to a commercial social media aggregator, such as GNIP or EagleAlpha, which “aggregates” the content from multiple social media sources providing a more scalable and curated source of Streaming Media Content 850 streaming data.

In the FIG. 4 illustration, the Stream Manager 902 is shown writing incoming raw social media data to the Raw Social Media 803 data store. The Raw Social Media 803 data store could comprise any valid System 10 data structure as previously described. In certain embodiments, the Raw Social Media 803 data store is used as a repository to maintain all or portions of all the original raw Streaming Media Content 850 provided by one or more Streaming Media Content 850 data streams. The Raw Social Media 803 data store may comprise individual data record elements such as the record id, time stamp, user name, text, shared (true when the status is shared or retweeted from a previous user), original user name (populated when the status is shared or retweeted), media URL that contains and URL's included in the data, and an indexed indicator which indicates that a particular record has been processed by a Media Monitors 900's Term Finder 903 and or Term Aggregator 904.

Certain embodiments of the Stream Manager 902 may populate all incoming Streaming Media Content 850 data stream records within the Raw Social Media 803 data store. This is advantageous in embodiments where the ability to review historical Streaming Media Content 850 data stream records for new Ticker Tag Terms or Phrases may be required. In a similar manner, all historical Media Content 100 identified by the Media Crawlers 200 could be maintained within one or more Document Stores 300 data structures and made available for the review and identification of new Ticker Tag Terms or Phrases as needed. In certain embodiments, historical content could also be used for error resolution and recovery purposes when needed.

However, in certain embodiments, only the Raw Social Media 803 data store records and Document Stores 300 data store records containing at least one identified Ticker Tag Term or Phrase may be maintained. Yet in other embodiments, a hybrid approach may be applied where Raw Social Media 803 data store records and Document Stores 300 data store records are purged as needed using any number of criteria suitable for a given System 10 embodiment.

In a particular System 10 embodiment, for instance, all Raw Social Media 803 data store records and Document Stores 300 data records could be maintained and then subsequently purged after a given time period of time. Purged records could be permanently deleted in some embodiments or migrated to a secondary source of backup media such as tape, online or offline disk, or another backup data system that is common in the art. In other embodiments, records could be selectively purged based upon other criteria such as using important Ticker Tags, Ticker Tag Terms or Phrases, or any other relevant criteria.

The Stream Manager 902 may utilize one or more instances of both the Term Finder 903 and the Term Aggregator 904 to process incoming Streaming Media Content 850 data records. Certain embodiment's Term Finder 903 instances may review the text and other relevant data features within the Streaming Media Content 850 data records provided by the Stream Manager 902 searching for relevant Ticker Tag Terms and Phrases made available for identification by the Term Loader 901.

In preferred embodiments, the Term Loader 901 provides access to all relevant Ticker Tag Terms and Phrases, Exclusion Terms, and any other terms which may be relevant for Stream Manager 902 processing. The Media Monitors 900 instance activates the Term Loader 901 when it is created. Terms and phases targeted by a particular Media Monitors 900 instance are made available in memory, via relational database tables, or in another manner suitable to a particular Media Monitors 900 embodiment by the Term Loader 901.

In some embodiments, each Stream Manager 902 instance connects to its specified Streaming Media Content 850 data stream adding the provided raw data stream records into the Raw Social Media 803 data store and providing the Term Finder 903 program module with input data for the identification of any relevant social media terms made available by the Term Loader 901. In certain embodiments, Term Finder 903 program module input data is immediately provided by a Stream Manager 902 instance as it arrives. Yet in other embodiments, one or more Term Finder 903 program module instances may monitor the Raw Social Media 803 data store for new data entries.

Certain configurations of the Media Monitors 900 may include a plurality of Raw Social Media 803 data stores and a plurality of Term Finder 903 program module instances processing streaming data provided by one or more Stream Manger 902 instances. Additional instances of the Media Monitors 900 and its associated program modules can be added to accommodate scalability and processing requirements or for any other necessary reason within a given embodiment.

Embodiments of the Term Finder 903 program module may use a tokenizer, such as the NLTK (Natural Language Toolkit), to transform input data provided by the Stream Manager 902 program module or data entries within the Raw Social Media 803 data store into potential Ticker Tag Terms and Phrases. For instance and as previously described, uni-grams, bi-grams, and tri-grams may be created in a manner similar to the steps described within the FIG. 2. Document Tokenizer 402 program module. However, the preferred Term Finder 903 embodiment processes will not necessarily require full Natural Language Processing such as part of speech tagging as performed in the Document Tokenizer 402 program module.

Certain embodiments of the Term Finder 903 may simply identify any potential Ticker Tag Terms and Phrases by capturing all word combinations for the longest known Ticker Tag Term or Phrase. For example, if the longest known Ticker Tag Term or Phrase includes only up to 3 words, all 1, 2, and 3, word phrases will be tokenized in the most efficient manner possible as potential Ticker Tag Terms and Phrases. In embodiments using a tokenizer, such as the NLTK (Natural Language Toolkit), this process is as simple as calling the word_tokenize() bigrams() and trigrams() functions while providing the targeted text as input.

Next, Term Finder 903 processing embodiments typically include looking up each potential Ticker Tag Term and Phrase identified within the list of targeted Ticker Tag Terms and Phrases made available by the Term Loader 901 for a given Media Monitors 900 instance. Upon the successful identification of a valid Ticker Tag Term or Phrase within the content provided by the Stream Manager 902, a Social Media Terms 804 entry is created.

In some embodiments, the Social Media Terms 804 entries include data elements such as a Ticker Term 801 record id, a Raw Social Media 804 record id, and a time stamp. The Social Media Terms 804 data store associates Raw Social Media 803 content with valid Tickers 800 and Ticker Terms 801 entries. Certain Media Monitors 900 embodiments could comprise a plurality of Raw Social Media 803, Social Media Terms 804, and SM Term Alerts 805 data stores.

Data entries in these data stores could be partitioned in any number of ways suitable for a particular Media Monitors 900 embodiment. For example, a plurality of Media Monitors 900 instances could be generated having each individual Media Monitors 900 instance dedicated to a particular Ticker Tag value. Yet in other embodiments, multiple lower volume Ticker Tags could be monitored by one Media Monitors 900 instance while a single high volume Ticker Tag has one or more dedicate Media Monitors 900 instances. In these embodiments, the Term Loader 901 may only provide Ticker Tag Terms and Phrases required for the Ticker Tags being serviced by a particular Media Monitors 900 instance. Furthermore, the Raw Social Media 803, Social Media Terms 804, and SM Term Alerts 805 data stores in such instances may be partitioned by the Ticker Tags monitored by a Media Monitors 900 instance.

In some embodiments, a Term Aggregator 904 operates in a manner conducive to generating aggregate Ticker Tag Term and Phrase statistics for the valid Ticker Tag Terms and Phrases identified by the Term Finder 903. Likewise, Ticker Tag Term and Phrase statistics generated by a particular Term Aggregator 904 embodiment could include any number of aggregate statistics of interest which are related to Ticker Tag Terms and Phrases monitored by a particular Media Monitors 900 instance. For example, Term Aggregator 904 statistics of interest may include data items such as the total number of times a valid Ticker Tag Term or Phrase identified by the Term Finder 903 has been encountered within a given Streaming Media Content 850 Data Stream. This information could also be aggregated by seconds, minutes, hours, days, or any other interval of time deemed important. Term Aggregator 904 statistics of interest may include the frequency of valid Ticker Tag Terms and Phrases observed in a particular data stream, social media platform, Ticker Tag Terms and Phrases referenced across multiple platforms, total Ticker Tag Terms and Phrases processed by a given System 10 or Media Monitors 900 instance, and any other Ticker Tag Term and Phrase statistics which may be of use for a given embodiment of this invention.

Using Ticker Tag Term and Phrase statistics or other available data elements and methods, some Term Aggregator 904 embodiments may generate Media Monitors 900 alerts which are placed into one or more SM Term Alerts 805 data stores. These “alert” entries could include data elements such as the time stamp, Ticker Terms 801 term id, the rank or importance of the alert, and a search preview text containing some of the original text which generated the alert. Certain embodiments may generate alerts when Ticker Tag Term and Phrase statistics exceed various thresholds set within a particular invention embodiment.

In one example embodiment, a Ticker Tag Term or Phrase alert may be generated when the frequency for a particular Ticker Tag Term or Phrase is two, five, or ten times greater for a given Streaming Media Content 850 Data Stream than its previous n observer intervals. In other embodiments, alerts may occur when one or more specific Ticker Tag Terms or Phrases is encountered in a particular data stream. Yet in other embodiments, alerts may occur when one or more specific Ticker Tag Terms or Phrases occur in combination within a particular Streaming Media Content 850 Data Stream.

In a preferred example embodiment of the Media Monitors 900, the Python programming language is used to define and connect to one or more Amazon Kinesis EC2 instances which scale elastically for real-time processing of streaming data at massive and variable scales. Within this embodiment, the Stream Manager 902 comprises a plurality of data-proces sing threads which are also defined using Python and or Amazon EC2 to consume the massive amount of real-time data streams produced by each of the Amazon Kinesis shards.

The Stream Manager 902 connects to the GNIP social media “decahose” and monitors the data available for processing. One EC2 instance of the Stream Manager 902 program module may be configured with one KCL worker and n record processors operating in parallel. In addition, the Stream Manager 902 may perform “resharding” operations to increase or decrease the number of shards in a stream in order to adapt to changes in the rate of data flowing through the stream.

In this embodiment, the KCL worker within the Stream Manager 902 tracks the shards in the stream using a data structure such as an Amazon DynamoDB table. When new shards are created as a result of resharding, the KCL discovers the new shards and populates new rows in the table. The workers automatically discover the new shards and create processors to handle the data from them. The KCL also distributes the shards in the stream across all the available workers and record processors. The KCL ensures that any data that existed in the shards prior to the resharding is processed first. After that data has been processed, data from the new shards is sent to record processors. In this way, the KCL preserves the order in which data records were added to the stream for a particular partition key.

When the application is scaled to use another Stream Manager 902 instance, one additional instance will be added processing one additional stream that has n shards. When the KCL worker starts up on the additional instance, it load-balances with the previous instances, so that each instance now processes an equal number of shards.

Each of the Stream Manager 902 worker instances include a Python defined program module for processing each of the records assigned to the worker. Each individual record is tokenized by Python's NLTK (Natural Language Tool Kit) producing uni-grams, bi-grams, and tri-grams as potential Ticker Tag Terms and Phrases. Next, each potential Ticker Tag Term and Phrase is looked up in the known Ticker Terms 801 hash table or a specific list of valid terms provided by the Term Loader 901. In addition, each potential Ticker Tag Term and Phrase is excluded if it appears within the Exclusion Terms 802 hash table. Raw Social Media 803 entries and Social Media Terms 804 entries are created for each Streaming Media Content 850 data record containing a valid Ticker Tag Term or Phrase. All related Term Aggregator 904 statistics are accumulated and valid SM Term Alert 805 entries are created as they occur.

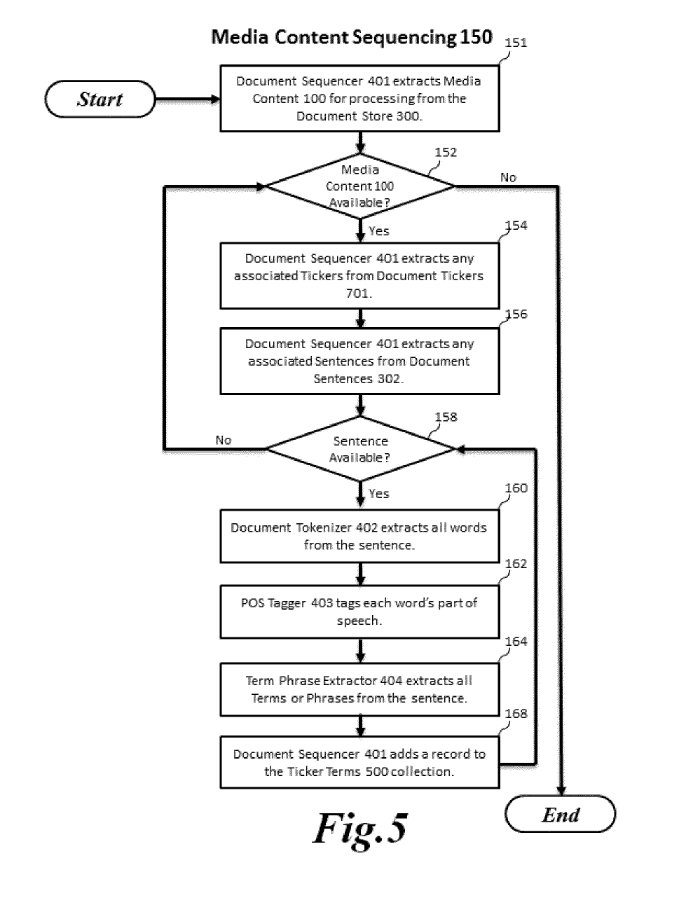

With reference to FIG. 5, there is shown a flow diagram illustrating a method for Media Content Sequencing 150 according to an exemplary embodiment. The flow diagram illustrates steps 151-168 for processing a Media Content 100 item and finally producing a Ticker Terms 500 collection entry. Starting at Step 151, the Document Sequencer 401 checks a Document Store 300 for an available entry which contains the relevant data related to a particular Media Content 100 item. At Step 152, the method ends when no more Document Store 300 entries are available for processing.

In certain embodiments, Document Store 300 entries may be partitioned across any number of Document Store 300 data structures. Likewise, any number of Media Crawlers 200 could be used to populate the Document Store 300 data structures. For example, a single Document Store 300 data structure may be populated by a single Media Crawlers 200 instance. Yet in another embodiment, multiple Media Crawlers 200 may populate a single Document Store 300 data structure. In some instances, Media Crawlers 200 may populate the Document Store 300 data structure as well as identify Ticker Tags and Sentences contained within a particular Media Content 100 item.

Step 154 continues processing for each available entry identified within a Document Store 300. First, the Document Sequencer 401 extracts any Ticker Tags associated with the Document Store 300 entry from the Document Tickers 301 data store. Continuing to Step 156, the Document Sequencer 401 also extracts any sentences identified from the within the Document Sentences 302 data store.

At Step 158, the Media Content Sequencing 150 process determines if any sentences were identified for this Document Store 300 entry. In the event no sentences exist, the Media Content Sequencing 150 process completes for the current Media Content 100 item by marking the Document Store 300 entry as processed. Next the method returns to Step 152 to obtain a new Document Store 300 entry for processing.

In the event that one or more sentences were identified for the current Media Content 100 item, processing proceeds to Step 160. In this step, the Document Sequencer 401 deploys a Document Tokenizer 402 program instance providing each sentence as input for tokenization. In certain embodiments, Step 160 and Step 162 are combined. For instance, in embodiments where the Natural Language Toolkit is utilized, the Media Content 100 item's sentences may already be tagged with the appropriate part of speech tags during Media Crawlers 200 processing. In these embodiments, part of speech tags may already be contained within a Document Sentences 302 data record.

In embodiments where the part of speech tags do not already exist, Step 162 executes the POS Tagger 403 to obtain the parts of speech for each word in the sentence. During Step 164, the Term Phrase Extractor 404 identifies all Ticker Tag Terms and Phrases within the sentence.

In some embodiments however, Term Phrase Extractor 404 processing may cross over sentence boundaries while identifying Ticker Tag Terms and Phrases. Such embodiments, may depend on Hidden Markov models or other machine learning techniques for the identification of Ticker Tag Terms and Phrases. These embodiments may extract Ticker Tag Terms and Phrases from text other than sentences such as paragraphs, text chunks of a particular length, or the entire collected text of a Media Content 100 item.

Once the Term Phrase Extractor 404 has identified a particular Ticker Tag Term or Phrase, a Ticker Terms 500 collection entry is created at Step 168. A Ticker Terms 500 collection entry associates the identified Ticker Tag Term or Phrase with each of the Ticker Tags extracted from the Document Tickers 301 data store or extracted directly from the Media Content 100 item's text. For example, a Media Content 100 item including multiple Ticker Tags would have each valid Term or Phrase identified within the document associated with each of the multiple Ticker Tags within the Ticker Terms 500 collection. Certain invention embodiments may also choose to capture statistics related to the frequency at which multiple Ticker Tags and/or Ticker Tag Terms and Phrases occur within the same Media Content 100. In the preferred embodiment, each data record within the Ticker Terms 500 collection comprises all Ticker Tag Terms and Phrases identified by the Term Phrase Extractor 404 and the appropriate set of keys to associate each collection of Ticker Tag Terms and Phrases to a Media Content 100 item contained within a Document Store 300.

In one example embodiment, all Document Store 300 records include a primary key to identify each unique Media Content 100 item called a URL ID or Document ID. All records in the Document Tickers 301 data store are associated with at least one unique Media Content 100 item within a Document Store 300 using the URL or Document ID as foreign key. Likewise, all records in the Document Sentences 302 data store are associated with at least one unique Media Content 100 item within a Document Store 300 using the URL or Document ID as foreign key. In such an embodiment, the Document Store 300 has a one-to-many relationship with both the Document Tickers 301 and Document Sentences 302 data stores. In other more sophisticated embodiments, additional partition or index number keys may exist to facilitate an appropriate mapping between these data stores when many instances of the data structures might be spread across a plurality of data store servers.

After adding one or more records to the Ticker Terms 500 collection, Step 168 returns processing to Step 158 until all available sentences or text for a document has been processed. At this point, Step 158 returns to Step 152 which searches for additional Media Content 100 entries within a Document Store 300. When all Document Store 300 entries have been processed, the method for Media Content Sequencing 150 is complete.

In certain embodiments, the method for Media Content Sequencing 150 may alternatively complete processing based on any number of heuristics defined within a particular System 10 embodiment. For example, the method for Media Content Sequencing 150 may complete processing when all Media Content 100 items for a particular Ticker Tag have been processed. In this embodiment, various Sequencer 400 systems may be assigned to individual Ticker Tags for processing. In yet other embodiments, the method for Media Content Sequencing 150 may complete processing after a certain number of Document Store 300 entries have been consumed or a competition/cancelation token is provided by the FIG. 1 System 10.

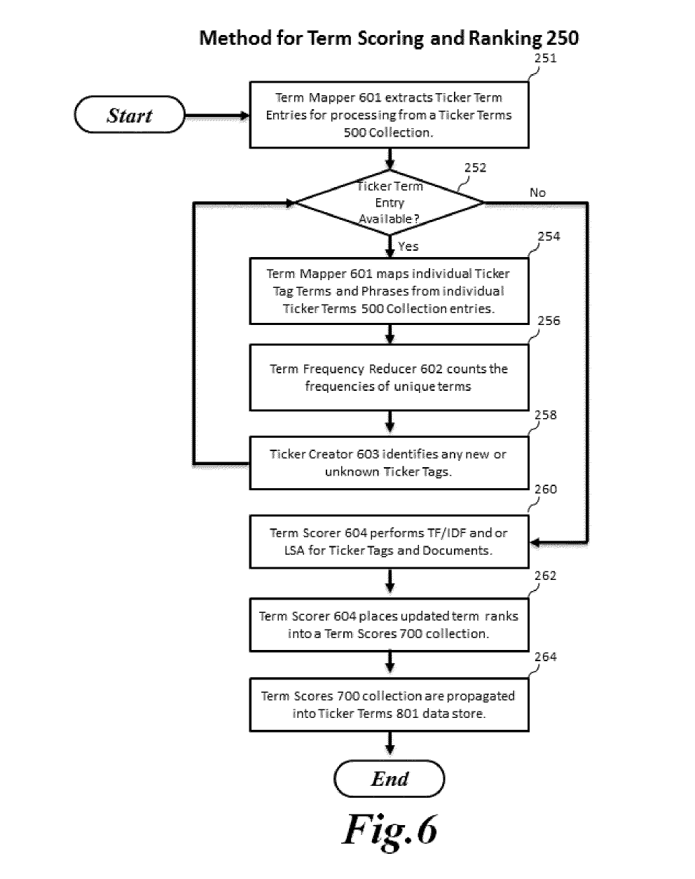

With reference to FIG. 6, there is shown a flow diagram illustrating a Method for Term Scoring and Ranking 250 according to an exemplary embodiment. The flow diagram illustrates steps 251-264 for the ranking and scoring of Ticker Tag Terms and Phrases. Each of the items referenced in FIG. 6 were previously described in great detail within FIG. 3.

In certain embodiments, each unique Ticker Tag Term and Phrase is scored for relevance to both Ticker Tags and Media Content 100 Items within a Document Store 300 as illustrated in FIG. 1 and FIG. 2. Other embodiments may only perform the Method for Term Scoring and Ranking 250 for either Ticker Tags or Media Content 100 items individually. Yet in other embodiments a blended score may also be calculated considering the relevance of a Ticker Tag Term or Phrase to both Ticker Tags and Media Content 100 Items in the Document Store 300.

Referring to Step 251, the Term Mapper 601 extracts one or more entries from a Ticker Terms 500 collection. One or more Term Mapper 601 program modules extract individual Ticker Tag Terms and Phrases from each individual Ticker Terms 500 collection data record. During Step 252, an individual Ticker Tag Term or Phrase is identified by parsing through the collection of Ticker Tag Terms and Phrases identified during the FIG. 3 Sequencer 400's processing steps.

Next in Step 254, each individual Ticker Tag Term or Phrase is “mapped” by the Term Mapper 601 and made available for processing by Term Frequency Reducer 602. In certain embodiments, the Term Mapper 601 may map Ticker Term 500 Collections in batches writing intermediate results to a file system or other centrally accessible location for immediate Term Frequency Reducer 602 processing. Yet in other embodiments where the both the Term Mapper 601 and the Term Frequency Reducer 602 may have access to the same memory or RAM, both the Term Mapper 601 and the Term Frequency Reducer 602 may access a thread safe centralized collection for exchanging mapping outputs and reduction inputs as they occur in real time.

Step 256 processing comprises the Term Frequency Reducer 602 counting the frequencies of each unique Ticker Tag Term or Phrase. In some embodiments, the Term Frequency Reducer 602 may also track the aggregate frequencies of Ticker Tag Terms and Phrases across both unique Ticker Tags and Document Store 300 entries. During Term Frequency Reducer 602 processing, new Ticker Tags are identified in Step 258. New Ticker Tags are placed in the Tickers 800 data structure by the Ticker Creator 603 during this step.

During Steps 252-258 the Individual Ticker Tag Terms or Phrases for each Ticker Terms 500 collection data entry are continually consumed. When additional Ticker Term 500 collection data entries exist processing returns to Step 252. However, when no more Ticker Term 500 collection entries are available, processing proceeds to Step 260.

The Term Scorer 604 performs Term Scoring as previously described using TF/IDF, LSA, both TF/IDF and LSA, or any other Term Scoring and Ranking algorithm which is common in the art and suitable for a particular embodiment. During Step 262, scores and/or ranks are calculated for individual Ticker Tag Terms and Phrases by either unique Ticker Tags, Media Content Items 100, or both unique Ticker Tags and Media Content Items 100 in certain embodiments.

Once Term Scorer 604 processing is completed, the Term Scorer 604 places updated Ticker Tag Term and Phrase scores into a Term Scores 700 collection in Step 262. In certain embodiments, the Term Scores 700 collection may comprise the TD/IFD scores for the relevance of Ticker Tag Terms and Phrases by Ticker Tag and/or Media Content Items 100 in the Document Stores 300.

Yet in other preferred embodiments, the Term Scores 700 collection may comprise scores in the form of a Ticker Tag Matrix or a Media Content Matrix representing the LSA calculated relevance of Ticker Tag Terms and Phrases by Ticker Tag and/or Media Content Items 100 in the Document Stores 300. Term Scores 700 collections provided by the Term Scorer 604 to await propagation into the Ticker Terms 801 data store. The Method for Term Scoring and Ranking 250 is completed at Step 264.

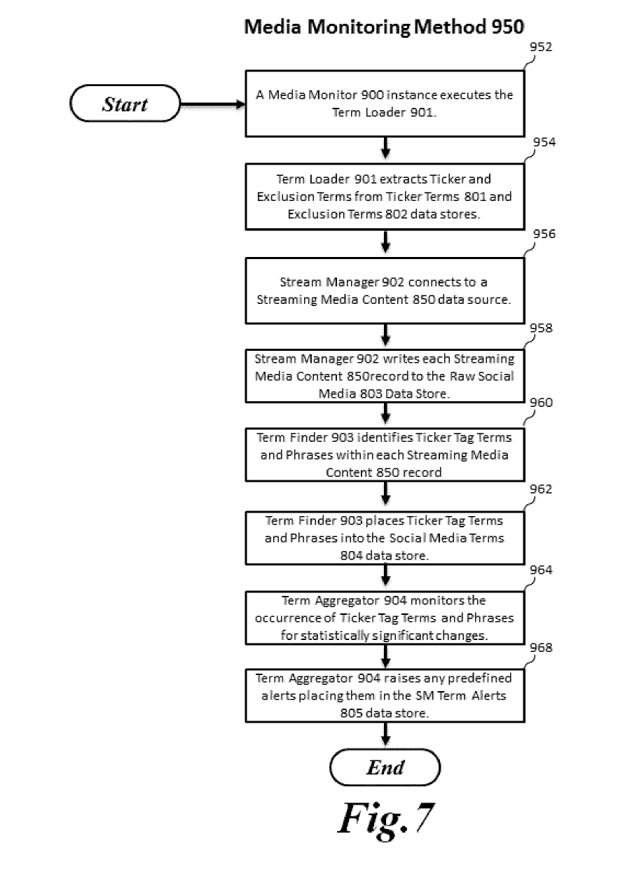

With reference to FIG. 7, there is shown a flow diagram illustrating a Media Monitoring Method 950 according to an exemplary embodiment of the present invention. The flow diagram illustrates steps 952-968 for the monitoring of Ticker Tag Terms and Phrases from one or more Streaming Media 850 data sources. Each of the items referenced in FIG. 7 were previously described in great detail within FIG. 4.

In certain embodiments, each unique Ticker Tag Term and Phrase is monitored for statistically significant changes in occurrence by one or more Media Monitors 900. Each Media Monitors 900 program module accepts one or more Streaming Media Content 850 data sources as input and produces one or more outputs including: Raw Social Media 803, Social Media Terms 804, and SM Term Alerts 805 data store entries according to the requirements of each specific embodiment.

In Step 952, the Media Monitors 900 executes the Term Loader 901 program module or engine. The Term Loader 901 program module typically comprises a program which facilitates the connection to and access of terms and phrases which are relevant to a particular instance of a Media Monitors 900 engine. Relevant terms and phrases could comprise both Ticker Tag Terms and Phrases and/or other terms and phrases list(s) which may be used for processing purposes. In the FIG. 4 embodiment, a Ticker Terms 801 and Exclusion Terms 802 data stores comprise both relevant Ticker Tag Terms and Phrases and other stop words, including profanity terms and phrases which should be ignored by the Media Monitors 900 instance.

During Step 954, the Term Loader 901 extracts all relevant terms and phrases making them available for Stream Manager 902 processing. In the FIG. 4 embodiment, the Term Loader 901 extracts all relevant Ticker Tag Terms and Phrases from the Ticker Terms 801 data store, and the Term Loader 901 extracts all exclusion terms and phrases from the Exclusion Terms 802 data store.

Next in Step 956, the Stream Manager 902 connects to a Streaming Media Content 850 data source. In various embodiments, the Streaming Media Data Source 850 could be a real time data stream or a data stream which provides records for processing in batches. In other embodiments, the Streaming Media Data Source 850 could comprise a specialized internet media crawler which searches for certain types of internet data such as comments, news, audio, video, or other data sources as they occur.

Step 958 comprises the Stream Manager 902 processing raw data records as they arrive from the Streaming Media Content 850 data source. In certain embodiments, processing typically includes capturing each raw data record in the Raw Social Media 803 data structure. While many valid Streaming Media Content 850 data source's content may comprise social media, many other valuable sources of data content could be envisaged. Streaming Media Content 850 data content could comprise any source of data which is deemed valuable in relation to a particular Ticker Tag.

The Term Finder 903 program module identifies the occurrence of any Ticker Tag Terms and Phrases made available by the Term Loader 901 within each Streaming Media Content 850 data record in Step 960. The Term Finder 903 program module parses a Streaming Media Content 850 data record's text looking for terms and phrases which may occur in the data record text and also exists within the Ticker Terms 801 terms and phrases made available by the Term Loader 901. The Term Finder 903 program module also excludes any terms and phrases within text that also includes the occurrence of any Exclusion Terms 802 made available by the Term Loader 901.

Finally, the Term Finder 903 places valid Ticker Tag Terms and Phrases into the Social Media Terms 804 data store in Step 962. The Social Media Terms 804 data store associates the occurrence of valid Ticker Tag Terms and Phrases within a particular Streaming Media Content 850 data source tracking various important occurrence attributes such as the time, date, source of the occurrence, and any Ticker Tags which may be associated with a particular Ticker Tag Term or Phrase.

During Step 964, the Term Aggregator 904 continually monitors the occurrence of Ticker Tag Terms and Phrases for statistically significant changes as they are added to the Social Media Terms 804 data store. In some embodiments, the Term Aggregator 904 tracks the frequency of each unique Ticker Tag Term or Phrase made available by the Term Loader 901 and present in any Streaming Media Content 850 data record. Some embodiment's Term Aggregator 904 may include any number of predefined thresholds which track Ticker Tag Term and Phrase occurrences across various classes. These classes could include intervals of time, Ticker Tags, Ticker Tag combinations, or dynamic thresholds based on comparing increases of previous time interval frequencies to current time interval frequencies to determine statistically significant changes in Ticker Tag Term and Phrase volumes from a particular Streaming Media Content 850 data source or across multiple Streaming Media Content 850 data sources.

Finally in Step 968, the Term Aggregator 904 raises any predefined alerts placing them in the SM Term Alerts 805 data store as they occur. In some embodiments of the invention, a valid SM Term Alerts 805 data entry could comprise data regarding any of the aforementioned thresholds which was exceeded. In other embodiments, any number of SM Term Alerts 805 entries could be conceived using data provided within the Media Monitor 900.

It will be appreciated by anyone of ordinary skill in the art that the disclosed subject matter may be embodied in other specific forms while in no way departing from the spirit or essential character of the teachings disclosed herein. Any embodiments presently disclosed are therefore considered in all respects as illustrative and do not limit the disclosed subject matter. The scope of the disclosed subject matter is indicated by the claims to follow rather than the foregoing specification, and all changes which come within the meaning and range of equivalents thereof are intended to be embraced therein.

1. A method operative in association with an information processing and curation system to identify information of interest with respect to publicly-traded stocks, each publicly-traded stock having an associated ticker symbol, comprising:
for each of a set of publicly-traded stock stocks, receiving and parsing media content to generate, as a tag library, a ranked set of ticker terms other than the associated ticker symbol, the ranked set of ticker terms in the tab library being curated at least in part by applying crowd-sourced information about one or more of the ticker terms received from a set of one or more third party curators;
for each publicly-traded stock of the set, real-time monitoring one or more of the generated ranked set of ticker terms in the tag library for that publicly-traded stock against one or more social media content streams, wherein, during real-time monitoring, a given ticker term instance within the one or more social media content streams is aggregated for trend analysis provided its usage within the one or more social media content streams has been shown to satisfy a context measure; and
based on results of the real-time monitoring and the trend analysis, the results providing an indication that a particular ticker term in the tag library is trending within the one or more social media content streams to a configurable degree, flagging for notification the particular ticker term and its associated publicly-traded stock to provide for an improved operation of the information processing and curation system.

2. The method as described in claim 1 further including issuing a notification that the particular ticker term and its associated publicly-traded stock are trending within the one or more social media content streams.

3. The method as described in claim 1 wherein the ranked set of ticker terms are generated by:
parsing the media content to generate document entries;
sequencing the document entries to generate the set of ticker terms;
scoring the set of ticker terms to generate the ranked set, wherein the scoring is based, with respect to a particular term, at least in part on statistics derived from a term frequency (TF), and an inverse document frequency (IDF).

4. The method as described in claim 3 wherein the parsing is operative to remove content or document formatting information.

5. The method as described 3 further including storing the document entries.

6. The method as described in claim 3 wherein the sequencing tokenizes document text in the document entries using variable-length n-grams.

7. The method as described in claim 6 wherein the sequencing further identifies one or more grammatical elements within the document text.

8. The method as described in claim 7 wherein the grammatical elements include one of: sentence boundary, paragraph boundary, capitalization, and part-of-speech (POS).

9. The method as described in claim 3 wherein the sequencing applies a machine learning (ML) model to document text in the document entries.

10. The method as described in claim 1 wherein the one or more ticker terms are excluded prior to the generating the ranked set.

11. The method as described in claim 3 wherein one or more of the parsing, sequencing and scoring operations occurs concurrently using parallel processing threads or instances.

12. The method as described in claim 1 wherein the media content is one of: web content, and RSS feeds.

13. (canceled)

14. The method as described in claim 2 wherein the notification is one of: an SMS, an e-mail, an alert message.

15. The method as described in claim 1 wherein the social media content streams includes at least one of: SMS content from an SMS-based information network, and Web-based content from a social network.

16. Apparatus associated with an information processing and curation system, comprising:
a processor;
computer memory holding computer program instructions executed by the processor to identify information with respect to each of a set of publicly-traded stocks, each publicly-traded stock of the set having an associated ticker symbol, the computer program instructions operative:
for each publicly-traded stock the set, to receive and parse media content to generate, as a tag library, a ranked set of ticker terms other than the associated ticker symbol, the ranked set of ticker terms in the tab library being curated at least in part by applying crowd-sourced information about one or more of the ticker terms received from a set of one or more third party curators;
for each publicly-traded stock of interest the set, to real-time monitor one or more of the generated ranked set of ticker terms in the tag library for that publicly-traded stock against one or more social media content streams, wherein, during real-time monitoring, a given ticker term instance within the one or more social media content streams is aggregated for trend analysis provided its usage within the one or more social media content streams has been shown to satisfy a context measure; and
based on results of the real-time monitoring and the trend analysis, the results providing an indication that a particular ticker term in the tag library is trending within the one or more social media content streams to a configurable degree, to flag for notification the particular ticker term and its associated publicly-traded stock to provide for an improved operation of the information processing and curation system.

17. The apparatus as described in claim 16 wherein the context measure is a machine learning (ML)-based context measure.
